(19) United States
(12) Patent Application Publication
(10) Pub. No.: US 2003/0191733 A1
(43) Pub. Date: Oct. 9, 2003

(54) System and method for data-mining a source code base to obtain module interface information

(76) Inventors: Christopher J. Kiick, Plano, TX (US); Nathan Vanderkraats, Richardson, TX (US)

Correspondence Address: HEWLETT-PACKARD COMPANY, Intellectual Property Administration, P.O. Box 272400, Fort Collins, CO, 80527-2400, US

(21) Appl. No.: 10/115,381

(22) Filed: Apr. 3, 2002

(51) Int. Cl. G06F 7/00

(52) U.S. Cl. 707/1

(57) ABSTRACT

A system and method for data mining a source code base, such as a Unix kernel, to obtain module interface information, thereby facilitating “modularization” of the code base is described. In one exemplary configuration, the invention is an extraction tool that extracts from a source code base exported programming interfaces for a given set of files defined as a module and produces a flat-data file of the extracted interfaces. The flat-data file is easily manipulable by other programs to extract specified data or generate reports, for example.

### BACKGROUND OF THE INVENTION

1. Technical Field of the Invention

The present invention generally relates to programming interfaces. More particularly, and not by way of any limitation, the present invention is directed to a system and method for data mining source code to obtain module interface information.

2. Description of Related Art

A large software project, such as the HP-UX kernel or the Linux kernel, generally comprises a large source code base that was not designed using modular or object-oriented design principles. In other words, the source code is not “modularized”. Identification of module interfaces would be useful in that such interfaces could be minimized and documented for development purposes. An interface could consist of variables, functions, macros, and constants that the module makes available to the other parts of the source code base. In addition, well-defined modular interfaces would be useful in identifying boundaries for “black box” testing, as well as for identifying violations of module interface specifications.

There exist tools that, given a particular symbol, will produce all of the uses of that symbol within a given code base, as well as tools that, given a file, will produce all of the symbols referenced by that file. However, no tool currently exists that will accept as input a set of files comprising a portion of a code base that have been defined as a module and subsequently output the interface to that module.

Existing tools for modular design assumed no existing code base and that the code would be written from the start using modules and object-oriented design principles. This is typically not the case with existing code bases. Existing tools for identifying interfaces do not permit the selection of what comprises a module; they either assume that every file is a module or that all files in a library comprise a single module. Existing tools for displaying information about a particular identifier do not use a data form that is easily manipulable by other programs while still being readable by humans.

### SUMMARY OF THE INVENTION

Accordingly, the present invention advantageously provides a system and method for data mining a source code base, such as a Unix kernel, to obtain module interface information, thereby facilitating “modularization” of the code base. In one exemplary configuration, the invention is an extraction tool that extracts from a source code base the exported programming interfaces for a given set of files defined as a module and produces a flat-data file of the extracted interfaces. The flat-data file is easily manipulable by other programs to extract specified data or to generate reports, for example.

In one aspect, the invention is directed to a method of identifying an interface to a module including at least one module source file, the method comprising the steps of identifying a first set of symbols including all unresolved symbols in the at least one module source file; identifying a second set of symbols including all external symbols in the at least one module source file; and identifying an intersection of the first and second sets, wherein the intersection of the first and second sets of symbols defines at least in part an interface for the module.

In another aspect, the invention is directed to a method of identifying an interface to a module including at least one module source file, the method comprising the steps of identifying a first set of symbols including all unresolved symbols in the at least one module source file; identifying a second set of symbols including all external symbols in the at least one module source file; for each of the identified external symbols, determining whether the identified external symbol is one of the identified unresolved symbols; and defining an interface for the module, wherein the defined interface includes all of the identified external symbols that are also identified as unresolved symbols.

In a further aspect, the invention is directed to a system for identifying an interface to a module including at least one module source file. The system comprises a software tool for identifying a first set of symbols that includes all unresolved symbols in the at least one module source file; a software tool for identifying a second set of symbols that includes all external symbols in the at least one module source file; and a software tool for identifying an intersection of the first and second sets, wherein the intersection of the first and second sets of symbols defines at least in part an interface for the module.

In a still further aspect, the invention is directed to a system for identifying an interface to a module including at least one module source file, the system comprising means for identifying a first set of symbols that includes all unresolved symbols in the at least one source file; means for identifying a second set of symbols theat includes all external symbols in the at least one module source file; means for determining whether each of the identified external symbol is one of the identified unresolved symbols; and means for defining an interface for the module, which interface comprises all of the identified external symbols that are also identified as unresolved symbols.

In yet another aspect, the invention is directed to a computer program product operable to identify an interface to a module comprising at least one module source file, the computer program product including a computer usable medium with computer readable program code thereon, the computer program product comprising program code operable to identify a first set of symbols comprising all unresolved symbols in the source files comprising the source code base; program code operable to identify second set of symbols comprising all external symbols in the module source files; and program code operable to identify an intersection of the first and second sets, wherein the intersection of the first and second sets of symbols comprises an interface for the module.

### BRIEF DESCRIPTION OF THE DRAWINGS

A more complete understanding of the present invention may be had by reference to the following Detailed Description when taken in conjunction with the accompanying drawings wherein:

FIG. 1 is a schematic block diagram of an environment in which an extraction tool may be employed to extract module interface information in accordance with the teachings of the present invention; and

FIG. 2 is a flow chart illustrating the method of the present invention for extracting module interfaces from a source code base.

### DETAILED DESCRIPTION OF THE DRAWINGS

In the drawings, like or similar elements are designated with identical reference numerals throughout the several views thereof, and the various elements depicted are not necessarily drawn to scale.

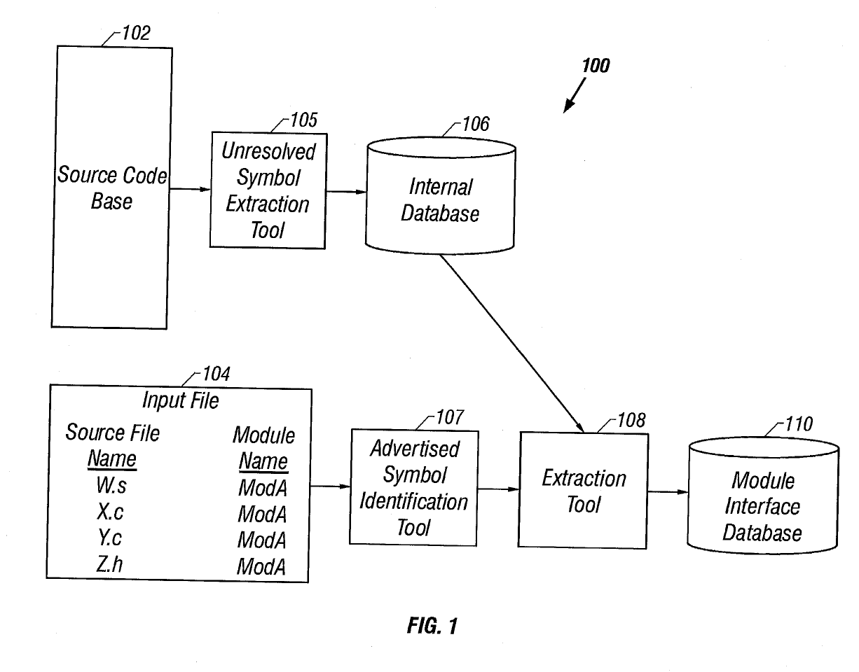

FIG. 1 is a schematic block diagram of an environment 100 in which an extraction tool may be employed to extract module interface information in accordance with the teachings of the present invention. In accordance with one implementation, at least one subset of files contained in a source code base 102, which may comprise, for example, a Unix kernel, is defined as a module. For purposes of illustration, it will be assumed that only one module has been defined; however, it will be recognized that the teachings of the present invention are applicable to any number of modules.

Once a module has been defined, an input file 104 including a list of source files and an indication of the module with which each file is associated, is generated. As shown in FIG. 1, source files W.s, X.c, Y.c, and Z.h have been defined as forming at least in part a module ModA. For purposes of example, only one module is shown as being defined by the input file 104; however, it will be recognized that, in practice, a single input file will likely define multiple modules. An unresolved symbol extraction tool 105 that identifies all of the symbols that a file references but that are not defined in the file is applied to each source file of the source code base 102. These symbols, which may be referred to as “imported symbols”, are stored in an internal database 106. In one embodiment, the tool 105 may be implemented using nm, which, as will be recognized by one of ordinary skill in the art, is an object tool included with a conventional C compiler. Alternatively, the tool 105 may be implemented with a variety of other tools, including, but not limited to, cscope, grep, a Perl script, or a purpose-written (i.e., special purpose) program.

Additionally, the source files listed in the input file 104 are input to an advertised symbol identification tool 107 that takes each of the source files for the module of interest and creates definitions of all of the symbols that could be referenced outside the file; i.e., those symbols that are not specifically declared to be only in that file. In one embodiment, the tool 107 is implemented using FlexeLint, which is a diagnostic tool commercially available from Gimbel Software of Collegeville, Pa. The tool 107 may also be implemented with a variety of other software tools, including, but not limited to, cscope, a C pre-processor, nm, a sed script, or a Perl script, for example. The list of external symbols (i.e., those symbols in the source files that may be referenced by other parts of the source code base 102) is input to an extraction tool 108.

The extraction tool 108 compares the list of external symbols with the database 106 of internal symbols. The intersection of the two sets of data is identified by the tool 108 as the interface to the module of interest, in this case, module ModA. The tool 108 creates an interface database 110 of information about each symbol that comprises the module interface, including the name of the file in which the symbol is defined, the files from which the symbol is referenced, and the name of the module. The interface database 110 is indexed by symbol name and is saved as a file that can be manipulated by other programs to extract additional data and generate reports, for example. In an exemplary implementation, the interface database file is generated as a flat data file.

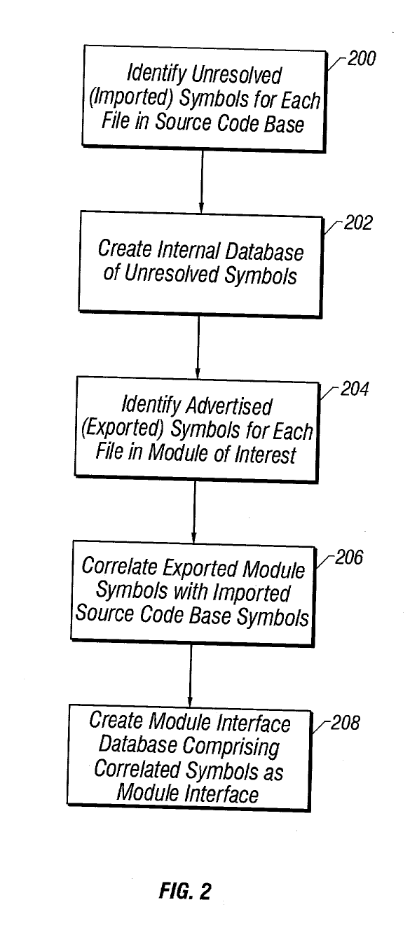

FIG. 2 is a flowchart of the operation of one embodiment of the extraction tool of the present invention. For ease of explanation, operation will be described with reference to a single module of interest; however, it will be recognized that the illustrated process may be applied to multiple modules. In steps 200 and 202, all of the unresolved, or imported, symbols in the source code base 102 are identified and stored internally in an internal database, such as the internal database 106 (FIG. 1). In an exemplary implementation, step 200 is accomplished by compiling the source files to object files and then applying the tool 105. The internal database is indexed on the name of the symbol and contains an indication of the source file from which the symbol is referenced.

In step 204, a list of all of the advertised, or external, symbols in the source files of the module of interest, as defined in an input file, such as the input file 104 (FIG. 1), is identified. In an exemplary implementation, this step is accomplished using the tool 107 (FIG. 1). In step 206, the extraction tool 108 (FIG. 1) correlates the exported module symbols identified in step 204 with the imported symbols stored in the internal database created in step 204. In step 208, the correlated symbols; that is, all of the external symbols that are located in the internal database in step 206, are defined as comprising the interface to the module of interest. The module interface is saved to an external file comprising a database, such as the module interface database 110 (FIG. 1). As previously indicated, the interface database is indexed by symbol and is saved as a file so that the data contained therein is easily manipulable by other programs.

It will be recognized that, although the steps of the operation described with reference to FIG. 2 are illustrated as being executed sequentially, one or more of the steps may be executed simultaneously and in a different order.

In one configuration, the data stored in the interface database is organized into records with fields. An exemplary record format is illustrated below.

BEGIN: name
LABEL:value[, value, value, . . . ]
. . .
END:-----------------

As illustrated above, each record is delimited with a BEGIN: END: pair. The name following the BEGIN: label is the record index. In this case, the name is a string representing the variable, function, or macro of the interface. This will be used as the default key for searches and sorts. The string after the END: label is ignored and is only provided for readability. Each field begins with its name, then a colon and then the value. The value must be one line. A list of values will be comma separated. There is no inherent length limit for field values.

Table I below sets forth several fields that are defined.

TABLE I

| NAME | TYPE | DESCRIPTION |
|---|---|---|
| FILE | string | the source file name for the interface |
| TYPE | enum | FUNC, VAR, MACRO |
| SCOPE | enum | GLOBAL, PRIVATE, STATIC |
| SUBSYS | enum | owner from kern. Owners, i.e., MDEP |
| AREA | enum | function area within SUBSYS |
| DECL | string | full type declaration or prototype of interface |
| EXTREF | enum list | list of subsystems referenced from |
| INTREF | enum list | list of functional areas referenced from |
| EXTCNT | int | number of external references |
| INTCNT | int | number of internal references |
| DESC | string | description of the interface (one line) |
| COMMENT | string | freeform comment |
| ARCH | enum | architecture dependency |
| HDR | string list | list of header files interface is exported in |
| FLAGS | enum list | special cases and flags |

An exemplary record is set forth below.

BEGIN:ike_invoke_callback

FILE:/ux/core/kern/common/plat/psm/ike_psm.c

TYPE:FUNC

SCOPE: GLOBAL

SUBSYS:MDEP

AREA:PLAT

DECL:extern void ike_invoke_callback(struct ike_ioc *);

EXTREF:10

EXTCNT:2

INTREF:

INTCNT:0

COMMENT:

DESC: invoke the callback given

ARCH:COMMON

HDR:

FLAGS: DIFF

END: - - -

An embodiment of the invention described herein thus provides a system and method for data-mining a source code base to obtain module interface information.

It is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims. For instance, while specific implementation examples have been described in reference to an illustrative configuration of the present invention, such implementations are merely illustrative. In particular, the source files may have different file extensions, including, but not limited to, .c, .s, and .h, for example. Additionally, source code bases other than Unix may be modularized according to the teachings of the present invention. Accordingly, all such modifications, extensions, variations, amendments, additions, deletions, combinations, and the like are deemed to be within the ambit of the present invention whose scope is defined solely by the claims set forth hereinbelow.

What is claimed is:

1. A method of identifying an interface to a module comprising at least one module source file, the method comprising:
identifying a first set of symbols including all unresolved symbols in the at least one module source file;
identifying a second set of symbols including all external symbols in the at least one module source file; and
identifying an intersection of the first and second sets, wherein the intersection of the first and second sets of symbols defines at least in part an interface for the module.

2. The method of claim 1 further comprising the step of adding the module interface to an interface database.

3. The method of claim 2 wherein the interface database is indexed by symbol.

4. The method of claim 2 wherein the interface database comprises a manipulable file.

5. The method of claim 2 wherein the interface database comprises a flat data file.

6. The method of claim 1 further comprising the step of preparing an input file, the input file including a list of module source files and, for each of the module source files, an indication of a module with which the module source file is associated.

7. A method of identifying an interface to a module comprising at least one module source file, the method comprising:
identifying a first set of symbols including all unresolved symbols in the at least one module source file;
identifying a second set of symbols including all external symbols in the at least one module source file;
for each of the identified external symbols, determining whether the identified external symbol is one of the identified unresolved symbols; and
defining an interface for the module, the defined interface including all of the identified external symbols that are also identified as unresolved symbols.

8. The method of claim 7 further comprising the step of storing all identified unresolved symbols in an internal database, wherein the internal database includes an entry for each identified unresolved symbol that indicates a module source file from which the identified unresolved symbol is referenced.

9. The method of claim 8 wherein the step of determining further comprises, for each of the identified external symbols, ascertaining whether the identified external symbol is included in the internal database.

10. The method of claim 7 further comprising the step of adding the defined module interface to an interface database.

11. The method of claim 10 wherein the interface database is indexed by symbol.

12. The method of claim 10 wherein the interface database comprises a manipulable file.

13. The method of claim 10 wherein the interface database comprises a flat data file.

14. The method of claim 7 further comprising the step of preparing an input file, the input file including a list of module source files and, for each of the module source files, an indication of a module with which the module source file is associated.

15. A system for identifying an interface to a module comprising at least one module source file, the system comprising:
a first software tool for identifying a first set of symbols comprising all unresolved symbols in the at least one module source file;
a second software tool for identifying a second set of symbols comprising all external symbols in the at least one module source file; and
a third software tool for identifying an intersection of the first and second sets, wherein the intersection of the first and second sets of symbols defines at least in part an interface for the module.

16. The system of claim 15 further comprising an interface database for storing the defined module interface.

17. The system of claim 16 wherein the interface database is indexed by symbol.

18. The system of claim 17 wherein the interface database comprises a manipulable file.

19. The system of claim 17 wherein the interface database comprises a flat data file.

20. The system of claim 16 further comprising an input file that includes a list of module source files and, for each of the module source files, an indication of a module with which the source file is associated.

21. The system of claim 15 wherein the first tool is a tool selected from a group consisting of nm, cscope, grep, a Perl script, and a special purpose program.

22. The system of claim 15 wherein the second tool is a tool selected from a group consisting of FlexeLint, nm, cscope, C pre-preprocessor, a Perl script, and a sed script.

23. A system for identifying an interface to a module comprising at least one module source file, the system comprising:
means for identifying a first set of symbols comprising all unresolved symbols in the at least one module source file;
means for identifying a second set of symbols comprising all external symbols in the at least one module source file;
means for determining whether each of the identified external symbols is one of the identified unresolved symbols; and
means for defining an interface for the module, the defined interface including all of the identified external symbols that are also identified as unresolved symbols.

24. The system of claim 23 further comprising means for storing all identified unresolved symbols in an internal database, wherein the internal database includes an entry for each identified unresolved symbol that indicates a module source file from which the identified unresolved symbol is referenced.

25. The system of claim 24 wherein the means for determining further comprises means for ascertaining whether each of the identified external symbols is included in the internal database.

26. The system of claim 23 further comprising means for adding the defined module interface to an interface database.

27. A computer program product operable to identify an interface to a module comprising at least one module source file, the computer program product including a computer usable medium with computer readable program code thereon, the computer program product comprising:
program code operable to identify a first set of symbols including all unresolved symbols in the at least one module source file;
program code operable to identify a second set of symbols including all external symbols in the at least one module source file; and
program code operable to identify an intersection of the first and second sets, wherein the intersection of the first and second sets of symbols defines at least in part an interface for the module.
